(19) United States
(12) Patent Application Publication
(10) Pub. No.: US 2025/0159762 A1
(43) Pub. Date: May 15, 2025

(54) SYSTEM FOR CONTROL OF HEATING GLASS

(71) Applicants: Hyundai Motor Company, Seoul (KR); Kia Corporation, Seoul (KR); Ajou University Industry-Academic Cooperation Foundation, Suwon-si (KR)

(72) Inventors: Kang Hee Lee, Hwaseong-si (KR); Gi Heon Jeong, Hwaseong-si (KR); Kyo Beum Lee, Seoul (KR); Hyung Woo Lee, Suwon-si (KR)

(21) Appl. No.: 18/804,925

(22) Filed: Aug. 14, 2024

(30) Foreign Application Priority Data
Nov. 14, 2023 (KR) 10-2023-0156846
Apr. 16, 2024 (KR) 10-2024-0050726

(51) Int. Cl. H05B 1/02; B60S 1/02; H05B 3/86

(52) U.S. Cl. CPC H05B 1/0236; B60S 1/026; H05B 3/86; H05B 2203/031

(57) ABSTRACT

An embodiment method of controlling a heating glass includes setting a designated temperature of the heating glass depending on temperature and humidity conditions measured through a sensor, calculating an applied power to reach the designated temperature based on an integrated thermal resistance formed in the heating glass, performing a phase shift of AC power of two or more phases to provide the calculated applied power to a load of the heating glass, and calculating a corrected power in consideration of a resolution of the sensor, wherein respective operations are controlled depending on a set control cycle.

### CROSS-REFERENCE TO RELATED APPLICATIONS

This application claims the benefit of Korean Patent Application No. 10-2023-0156846, filed on Nov. 14, 2023, and Korean Patent Application No. 10-2024-0050726, filed on Apr. 16, 2024, which applications are hereby incorporated herein by reference.

### TECHNICAL FIELD

The present disclosure relates to a system and method of controlling a heating glass.

### BACKGROUND

A vehicle includes a heating glass located at the front and rear of the vehicle and performs the function of raising the surface temperature of the heating glass by applying power to a load located in the heating glass to prevent condensation inside and outside the heating glass so as to secure a driver's field of view.

That is, it is important to control the temperature of the load located in the heating glass of the vehicle to prevent condensation that occurs in a saturated water vapor state by raising the temperature of the heating surface glass in response to the relative humidity diagram.

However, there is a problem that a lot of power is consumed to supply power to the load of the heating glass to maintain a constant temperature. Further, conventionally, there were efforts to provide a constant duty ratio to control heating temperatures of a large number of heating glasses having various sizes and loads.

The above information disclosed in this background section is only for enhancement of understanding of the background of embodiments of the disclosure, and therefore it may contain information that does not form the already known prior art.

Korean Patent Application No. 10-2008-0098779 may provide additional information related to the technology discussed herein.

### SUMMARY

The present disclosure relates to a system and method of controlling a heating glass. More particularly, it relates to a system and method of controlling a heating glass which provides optimal applied power to a heating glass based on a temperature model transfer function in which integrated thermal resistance is set as a factor.

Embodiments of the present disclosure can solve problems associated with the prior art, and an embodiment of the present disclosure sets an optimal applied power applied to a heating glass through a heating glass control method.

Another embodiment of the present disclosure provides a method of controlling a heating glass in which, when applied power in a corresponding control cycle is calculated by reflecting a temperature and humidity measured by a sensor (i.e., a sensor) depending on the control cycle, the power is calculated by reflecting a vehicle's driving environment.

Yet another embodiment of the present disclosure provides a method of controlling a heating glass in which, in order to solve the problem that applied power calculated depending on a low-resolution sensor is set to 100% or 0%, a heat dissipation slope depending on a temperature drop value is calculated, and the applied power is corrected based on the heat dissipation slope.

The embodiment of the present disclosure are not limited to the above-mentioned embodiments, and other embodiments of the present disclosure that are not mentioned may be understood by the following description and may be more clearly understood by the exemplary embodiments of the present disclosure. Further, the embodiments of the present disclosure may be realized by means and combinations thereof as indicated in the claims.

To achieve the above features of embodiments of the present disclosure, a method of controlling a heating glass includes the following configuration.

One embodiment of the present disclosure provides a method of controlling a heating glass including setting, by a controller, a designated temperature of the heating glass depending on temperature and humidity conditions measured through a sensor, calculating, by the controller, applied power to reach the designated temperature based on an integrated thermal resistance formed in the heating glass, performing, by the controller, phase shift of AC power of two or more phases to provide the calculated applied power to a load of the heating glass, and calculating, by the controller, corrected power in consideration of a resolution of the sensor, wherein the controller is configured to control respective operations depending on a set control cycle.

In a preferred embodiment, setting, by the controller, the designated temperature of the heating glass depending on the temperature and humidity conditions measured through the sensor may include receiving outdoor temperature and humidity conditions and indoor temperature and humidity conditions of a vehicle through an outdoor sensor located outside the heating glass and an indoor sensor located inside the heating glass and setting, by the controller, designated temperatures based on the received outdoor temperature and humidity conditions and the received indoor temperature and humidity conditions of the vehicle.

In another preferred embodiment, the method may further include calculating, by the controller, an outdoor integrated thermal resistance and an indoor integrated thermal resistance through the outdoor temperature and humidity conditions and the indoor temperature and humidity conditions of the vehicle, calculating, by the controller, outdoor applied power depending on the calculated outdoor integrated thermal resistance and indoor applied power depending on the calculated indoor integrated thermal resistance, and providing a relatively large applied power by comparing the calculated outdoor applied power and the calculated indoor applied power with each other.

In still another preferred embodiment, the applied power in a current control cycle may be calculated through Equation 1 below.

$${R}_{th} [ K - 1 ] = \frac{{T}_{glass} [ K ] - {T}_{glass} [ K - 1 ]}{P [ K - 1 ]} , P [ K ] = \frac{T * - {T}_{glass} [ K ]}{{R}_{th} [ K - 1 ]} \qquad Equation 1$$

(P[K]: applied power in K^{th} control cycle, Rₜₕ: integrated thermal resistance, T_{glass}: temperature of heating glass, T*: designated temperature, K: control cycle number.)

In yet another preferred embodiment, the integrated thermal resistance may be a sum of radiative thermal resistance and a convective thermal resistance of the heating glass.

In still yet another preferred embodiment, the integrated thermal resistance may be calculated in consideration of a heat loss of the heating glass.

In a further preferred embodiment, in setting, by the controller, the designated temperature of the heating glass depending on the temperature and humidity conditions measured through the sensor, the controller may set the designated temperature to a temperature at which relative humidity is 80% to 90% based on a psychrometric chart.

In another further preferred embodiment, in setting, by the controller, the designated temperature of the heating glass depending on the temperature and humidity conditions measured through the sensor, the temperature of the heating glass in a current control cycle may be calculated through Equation 1 above based on an integrated thermal resistance and a temperature of the heating glass in a previous control cycle.

In still another further preferred embodiment, calculating, by the controller, the corrected power in consideration of the resolution of the sensor may include, if the resolution of the sensor is less than or equal to a set value, calculating, by the controller, a heat dissipation slope depending on a temperature drop after reaching the designated temperature of the heating glass, setting, by the controller, the corrected power based on the calculated heat dissipation slope, and performing, by the controller, the phase shift of the AC power of the two or more phases to provide the corrected power to the load of the heating glass.

In yet another further preferred embodiment, it may be determined that the resolution of the sensor is less than or equal to the set value if power applied to the heating glass after the temperature of the glass temperature has converged on the designated temperature has a power value of 0% or 100% of power supplied from the power supply.

In still yet another further preferred embodiment, if the resolution of the sensor is less than or equal to the set value, the corrected power may be set after the applied power calculated in the control cycle has been applied to the heating glass.

In a still further preferred embodiment, the heat dissipation slope may be calculated through Equation 2 below.

$$Δ {T}_{glass} = \frac{{T}_{glass} [ {K}_{t} - 1 ] - {T}_{glass} [ {K}_{t} ]}{{t}_{d}} \qquad Equation 2$$

(T_{glass}[Kₜ−1]: temperature of heating glass before temperature drop after reaching designated temperature, T_{glass}[Kₜ]: temperature of heating glass after temperature drop, t_{d}: time when temperature drop from designated temperature occurs, K: control cycle number.)

In a yet still further preferred embodiment, the corrected power may be calculated through Equation 3 below.

$${P}_{correct} [ K ] = {P}_{correct} [ K - 1 ] + {K}_{c} \times {P}_{r} \times Δ {T}_{glass} \times {t}_{samp}$$

(P_{correct}[K]: corrected power, A T_{glass}: heat dissipation slope, tₛₐₘₚ: control cycle time, K: control cycle number, Pᵣ: rated power.)

In yet another further preferred embodiment, in calculating the heat dissipation slope depending on the temperature drop after reaching the designated temperature of the heating glass, the heat dissipation slope may be calculated based on a time for which the applied power is 0 W.

In still yet another further preferred embodiment, the heat dissipation slope may be calculated based on a time when the temperature of the heating glass drops from the designated temperature by a temperature corresponding to a minimum unit of the resolution of the sensor.

Other aspects and preferred embodiments of the disclosure are discussed infra.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a block diagram showing the configuration of a system for controlling a heating glass according to one embodiment of the present disclosure;

FIG. 2 is a diagram showing the configuration of integrated thermal resistance of the system according to one embodiment of the present disclosure;

FIG. 3 is a flowchart representing a method of controlling a heating glass according to one embodiment of the present disclosure;

FIG. 4 is a flowchart representing a method of controlling a heating glass including indoor and outdoor sensors according to another embodiment of the present disclosure;

FIGS. 5A and 5B are graphs showing the temperature and applied power of the heating glass in the method according to one embodiment of the present disclosure;

FIG. 6 is a flowchart representing calculation of corrected power in the method according to one embodiment of the present disclosure;

FIG. 7 is a graph showing a temperature change of the heating glass depending on a control cycle according to one embodiment of the present disclosure;

FIGS. 8A and 8B are graphs showing a change in power applied to the heating glass depending on the control cycle; and

FIG. 9 is an equivalent circuit forming the heating glass according to one embodiment of the present disclosure.

It should be understood that the appended drawings are not necessarily to scale, presenting a somewhat simplified representation of various preferred features illustrative of the basic principles of embodiments of the disclosure. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION OF ILLUSTRATIVE EMBODIMENTS

Hereinafter, reference will be made in detail to various embodiments of the present disclosure, examples of which are illustrated in the accompanying drawings and described below. The present disclosure is not limited to the following embodiments, and the embodiments may be implemented in various different forms. The embodiments are provided to make the description of the present disclosure thorough and to fully convey the scope of the present disclosure to those skilled in the art.

Further, in the following description of the embodiments, it will be understood that the suffixes “ . . . part,” “ . . . unit,” “ . . . module,” etc. indicate units for processing at least one function or operation and may be implemented as software, hardware, or a combination of software and hardware.

Further, the terminology used herein is for the purpose of describing particular embodiments only and is not intended to be limiting. As used herein, singular expressions may be intended to include plural expressions as well, unless the context clearly indicates otherwise.

In addition, in the following description of embodiments of the present disclosure, terms, such as “first” and “second,” are used only to distinguish one element from other elements, and the order thereof is not necessarily limited in the following description.

Further, in the following description of embodiments of the present disclosure, applied power refers to power applied to glass and means power which is less than or equal to a set rated power. The applied power applied to the glass below may refer to applied power calculated by a controller and may also be understood as a concept that includes power that does not exceed the rated power.

Further, in the following description of embodiments of the present disclosure, a controller 40 may be implemented through a memory that stores data regarding an algorithm configured to control operations of various elements disposed in a vehicle or a program configured to reproduce the algorithm and a processor that executes the above-described operations using the data stored in the memory. Here, the memory and the processor may be implemented as individual chips. Otherwise, the memory and the processor may be implemented as a single chip. For example, the controller 40 may include at least one of an electronic control unit (ECU), a central processing unit (CPU), a microprocessor unit (MPU), a microcontroller unit (MCU), an application processor (AP), or any arbitrary processor which is well known to those skilled in the art to which the present disclosure pertains. Further, the controller 40 may be implemented as a combination of software and hardware which may perform calculations in at least one application or program configured to execute methods according to the embodiments of the present disclosure.

A heating glass of embodiments of the present disclosure is a concept that includes not only a heating glass including a load used as a heat source but also an electrochromic glass, and embodiments of the present disclosure relate to a method and system which calculate applied power applied to a load if an object is a heating glass and calculate the applied power to control an amount of color changes if the object is an electrochromic glass.

Hereinafter, a heating glass will be described as an example, but the heating glass may be replaced with an electrochromic glass.

Hereinafter, embodiments of the present disclosure will be described in detail with reference to the accompanying drawings, and in the description with reference to the accompanying drawings, the same or corresponding components will be denoted by the same reference numerals even though they are depicted in different drawings, and a detailed description of redundant contents thereof will be omitted.

The present disclosure relates to a system and method for controlling a heating glass 10 located in a vehicle that calculates power applied to the heating glass 10 and provides the calculated applied power of the heating glass 10 through phase shift of AC power of two or more phases.

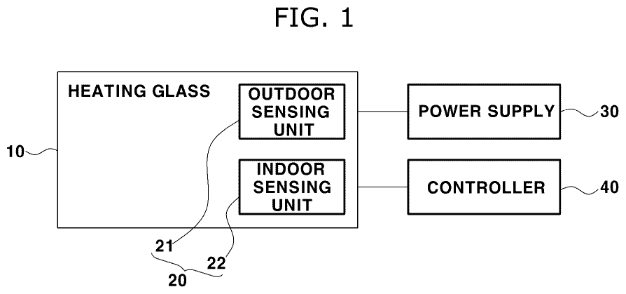

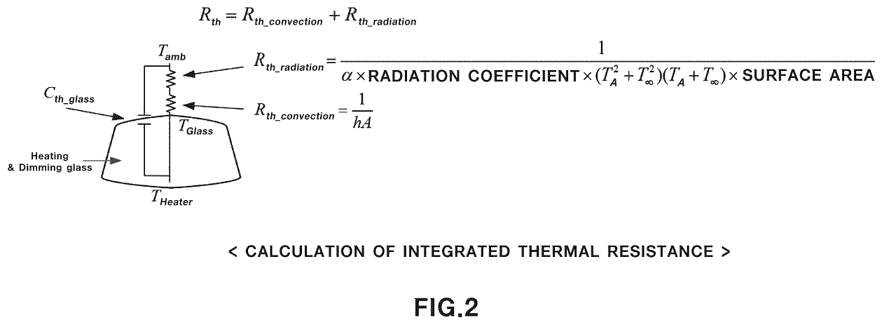

FIGS. 1 and 2 show the configuration of the system for controlling the heating glass 10 according to one embodiment of the present disclosure.

The heating glass 10 refers to glass located on the front, rear, or side surface of the vehicle, and heat is provided to the heating glass 10 through a load located in the heating glass 10. Further, the load is configured to be conductively connected to a power supply 30 located in the vehicle, and the power supply 30 is controlled to apply power to the load by the controller 40.

Further, the power supply 30 may be configured to provide AC power of two or more phases and may provide applied power set by the controller 40 to the load through the AC power of the two or more phases. The power supply 30 may supply power through a battery located in the vehicle and may convert DC power into AC power using an AC-DC converter to provide the applied power to the heating glass 10.

A sensor 20 may measure temperature and humidity outside the heating glass 10 or inside the vehicle based on the heating glass 10. In one embodiment of the present disclosure, the sensor 20 may include an outdoor air temperature sensor, an in-car sensor, and/or an auto-defog sensor.

The outdoor air temperature sensor is located outside the vehicle and is configured to measure an outdoor air temperature while the vehicle is driving. Moreover, there are two types of outdoor air temperature sensors, one is an ambient (AMB) sensor which is dedicated to temperature measurement, and the other is an air quality sensor (AQS) which is an air quality measurement device to measure temperature and automatically switch between indoor air and outdoor air in an air conditioner.

Further, in one embodiment of the present disclosure, the in-car sensor is a sensor that senses the temperature of indoor air inside the vehicle, and an automatic temperature control device may measure the indoor temperature of the vehicle using the temperature sensed by the in-car sensor.

The auto-defog sensor may predict and/or detect fogging that has begun to form on the surface of the heating glass 10, and in the vehicle, the auto-defog sensor may be employed on the inner surface of the heating glass 10 of the vehicle.

The auto-defog sensor may include a temperature sensor to measure the temperature of the inner surface of the heating glass 10 and a relative humidity sensor. Moreover, in order to calculate a relatively accurate dew point temperature, the relative humidity sensor and the in-car sensor of the vehicle are adjacent to each other to measure humidity and temperature at the same point.

Further, the temperature sensor located in the auto-defog sensor is located in contact with the surface of the heating glass 10 or is configured to have a designated gap with the surface of the heating glass 10. Therefore, the auto-defog sensor may measure the current temperature of the heating glass 10 and transmit the measured current temperature to the controller 40.

Furthermore, as the sensor 20 according to embodiments of the present disclosure, an outdoor sensor 21 may include the outdoor air temperature sensor, and an indoor sensor 22 may include the auto-defog sensor or the in-car sensor.

The controller 40 receives current measured values of the outdoor air temperature and the indoor temperature of the vehicle and the temperature of the heating glass 10 through the outdoor air temperature sensor, the in-car sensor, and the auto-defog sensor as the sensor 20. Furthermore, considering each received temperature condition, the controller 40 may calculate a current heat capacity of the heating glass 10, a heat exchange capacity between the heating glass 10 and the exterior of the vehicle, and a heat exchange capacity between the heating glass 10 and the interior of the vehicle.

Moreover, the controller 40 may measure the temperature of the heating glass 10 of the vehicle in the first control cycle through the outdoor air temperature sensor. That is, it may be determined that the outdoor air temperature and the temperature of the heating glass 10 are the same in the state of thermal equilibrium, and based on this, the temperature of the heating glass 10 in the first control cycle may be set based on the outdoor air temperature.

Furthermore, in control cycles that are continuously performed after the first control cycle, the current temperature of the heating glass 10 may be calculated as the sum of the initial outdoor air temperature and the product of an integrated thermal resistance and applied power. That is, when calculating the temperature of the heating glass 10, the controller 40 may calculate the temperature of the heating glass 10 in a current control cycle through a relationship with the outdoor air temperature based on an integrated thermal resistance and applied power calculated in a previous cycle. Further, the controller 40 is configured to calculate applied power in the current control cycle based on the integrated thermal resistance and the applied power calculated in the previous cycle and a designated temperature in the current control cycle.

Therefore, the controller 40 may calculate the integrated thermal resistance in the first control cycle, and in subsequent control cycles, it may calculate the current temperature of the heating glass 10 in the current control cycle and the applied power in the current control cycle based on the integrated thermal resistance calculated in the previous cycle.

Alternatively, in another embodiment of the present disclosure, since the sensor 20 may measure the temperature of the heating glass 10 in the current control cycle and may transmit the measured temperature of the heating glass 10 to the controller 40, the controller 40 may calculate applied power in the current control cycle based on the integrated thermal resistance in the previous control cycle.

The controller 40 is controlled to apply applied power to the heating glass 10 depending on a set control cycle, and, if the applied power is set, the controller 40 is configured to perform phase shift of AC power of two or more phases based on the set applied power to apply the power to the heating glass 10.

Further, the controller 40 is configured to receive temperature and humidity information through the sensor 20 and calculate the designated temperature based on a psychrometric chart pre-stored in the controller 40. The designated temperature is calculated through comparison with a saturated water vapor pressure curve of the psychrometric chart stored in the controller 40 and may be set so that the relative humidity becomes 80% to 90%.

The designated temperature is set so that the relative humidity is less than 100%, and the controller 40 calculates the integrated thermal resistance of the heating glass 10 depending on the designated temperature.

The integrated thermal resistance of the heating glass 10 is calculated by summing a radiative thermal resistance and a convective thermal resistance of the heating glass 10 and is calculated using Equations 4 and 5 below.

### Radiative Thermal Resistance.

$${R}_{th - radiation} = \frac{1}{\begin{matrix}a \times radiation coefficient \times \\ ( {T}_{A}^{2} + {T}_{∞}^{2} ) ( {T}_{A} + {T}_{∞} ) \times surface area\end{matrix}} \qquad Equation 4$$

(a: Stafan-Boltzmann constant, T_{A}: surface temperature of heating glass, T_{∞}: atmospheric temperature)

### Convective Thermal Resistance.

$${R}_{th - radiation} = \frac{1}{hA} \qquad Equation 5$$

(h: convective heat transfer coefficient [W/m2K], A: area of heating glass.)

That is, embodiments of the present disclosure are configured to calculate the applied power by calculating the integrated thermal resistance through equivalent circuit conversion of the heating glass 10 and calculating a thermal resistance and a heat capacity depending on a driving environment varied depending on each control cycle.

In addition, an RC parallel equivalent circuit may be set through the thermal resistance and the heat capacity of the heating glass 10 calculated in this way, and thus, a temperature model transfer function of the heating glass 10 may be calculated as follows.

Moreover, the integrated thermal resistance may be calculated in consideration of the heat loss of the heating glass 10, and the heat loss of the heating glass 10 may be stored in or calculated by the controller 40 based on the temperature of the heating glass 10 and atmospheric temperature.

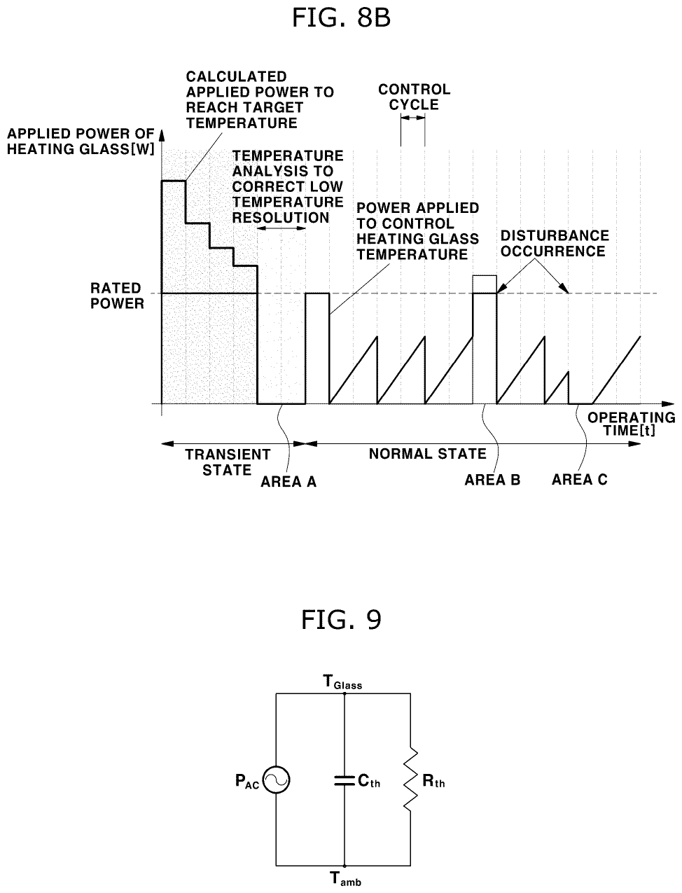

The equivalent circuit forming the heating glass 10 is as disclosed in FIG. 9.

The temperature model transfer function depending on the equivalent circuit may be set to Equation 6 below.

$${Glass}_{th} ( S ) = \frac{{R}_{th}}{1 + {R}_{th} {C}_{th} S} \qquad Equation 6$$

Here, Glassₜₕ (S) indicates a transfer function calculated depending on each control cycle based on the integrated thermal resistance and the heat capacity.

Therefore, the thermal model transfer function of the heating glass 10 may be set based on the heat capacity and the calculated integrated thermal resistance of the heating glass 10, and the controller 40 may calculate the applied power based on the set transfer function.

If the applied power is calculated, the controller 40 may control the power supply 30 which provides AC power of two or more phases. In one embodiment of the present disclosure, the power supply 30 is configured to apply three-phase AC voltage to the heating glass 10, and thus, the controller 40 performs phase shift of the three-phase AC voltage and applies AC power corresponding to the applied power to the heating glass 10.

Further, the controller 40 may be configured to calculate respective integrated thermal resistances depending on the outdoor sensor 21 and the indoor sensor 22, calculate applied powers depending on the respective integrated thermal resistances, and perform phase shift of the power supply 30 in response to a large one among the calculated applied powers.

This serves to set applied power to prevent condensation and frost outside the heating glass 10, thereby being capable of improving a driver's field of view.

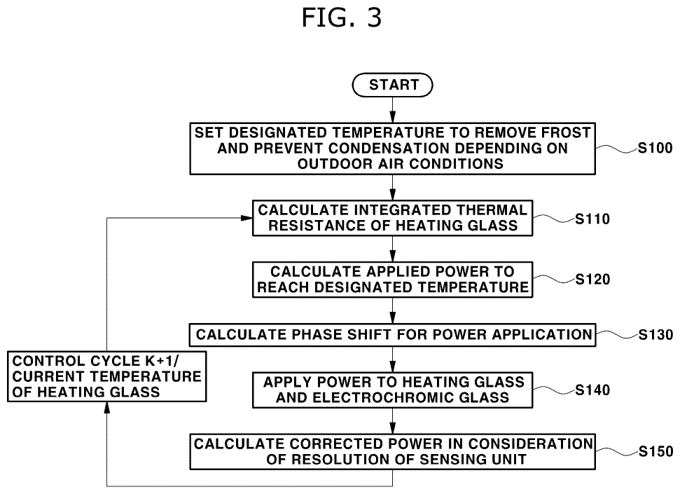

FIG. 3 is a flowchart representing a method of controlling the heating glass 10 using one sensor 20 according to one embodiment of the present disclosure.

As shown in this figure, the controller 40 receives driving condition information of the vehicle measured by the sensor 20. The driving condition information of the vehicle includes outdoor temperature and humidity information of the vehicle. Further, the temperature of the heating glass 10 is determined to be the same as the outdoor air temperature in the initial thermal equilibrium state.

The controller 40 sets a designated temperature at which a relative humidity is 80% to 90% depending on the psychrometric chart stored in the controller 40 based on the temperature and humidity information received from the sensor 20 (S100).

Further, the controller 40 calculates the integrated thermal resistance of the heating glass 10, and in this case, calculates the integrated thermal resistance by summing the radiative resistance and the convective resistance of the heating glass 10 (S110). Thereafter, the controller 40 may calculate applied power to raise the temperature of the heating glass 10 to the designated temperature depending on the calculated integrated thermal resistance (S120).

Here, the controller 40 calculates the radiative thermal resistance using Equation 4 above and calculates the convective thermal resistance using Equation 5 above to calculate the integrated thermal resistance.

After calculating the applied power, the controller 40 calculates the phase shift of the power supply 30 including the AC power of the two or more phases (S130) and applies phase-shifted power to the heating glass 10 (S140).

In this way, the controller 40 according to embodiments of the present disclosures performs respective operations of the method of controlling the heating glass 10 in one control cycle and then continuously performs the respective operations in the next control cycle. Here, since the temperature of the heating glass 10 is different from the temperature of the heating glass 10 in the thermal equilibrium state in the first control cycle, the controller 40 calculates the temperature of the heating glass 10 in the current control cycle based on the applied power applied in the previous control cycle (Silo).

Further, the controller 40 calculates the applied power in the current control cycle based on the integrated thermal resistance calculated in the previous control cycle. That is, in successive control cycles, the current temperature of the heating glass 10 in the current control cycle and the applied power in the current control cycle may be calculated based on factors in the previous control cycle.

In one embodiment of the present disclosure, the temperature and applied power of the heating glass 10 in the current control cycle may be calculated according to Equation 1.

$${R}_{th} [ K - 1 ] = \frac{{T}_{glass} [ K ] - {T}_{glass} [ K - 1 ]}{P [ K - 1 ]} , P [ K ] = \frac{T * - {T}_{glass} [ K ]}{{R}_{th} [ K - 1 ]} \qquad Equation 1$$

(P[K]: applied power in K^{th} control cycle, Rₜₕ: integrated thermal resistance, T_{glass}: temperature of heating glass, T*: designated temperature, K: control cycle number.)

That is, the temperature of the heating glass 10 in the current control cycle may be calculated through the sum of the temperature of the heating glass 10 in the previous control cycle and the product of the integrated thermal resistance in the previous control cycle and the applied power in the previous control cycle, and the applied power in the current control cycle may be determined by comparing the integrated thermal resistance in the previous control cycle and the temperature of the heating glass 10 in the current control cycle with the designated temperature.

In one embodiment of the present disclosure, the controller 40 may receive the temperature of the heating glass 10 in the current control cycle through the sensor 20, and in another embodiment of the present disclosure, the controller 40 may calculate the temperature of the heating glass 10 in the current control cycle as the sum of the temperature of the heating glass 10 in the previous control cycle and the product of the integrated thermal resistance in the previous control cycle and the applied power in the previous control cycle.

This is a configuration to calculate the applied power in the current control cycle in response to the previous control cycle by applying the integrated thermal resistance to linearize the temperature of the heating glass 10 having non-linear thermal characteristics depending on the control cycle. Therefore, in order to perform accurate calculation of the temperature of the heating glass 10 modeled as a thermal circuit, a process of calculating all non-linear equations, such as for radiative thermal resistance and convective thermal resistance, to calculate the thermal resistance of a thermal model may be simplified. Further, in order to easily calculate the non-linear equations through linearization, the applied power in the current control cycle may be calculated by linearizing the non-linear equations through calculation of the integrated thermal resistance using the applied power and the changed temperature of the heating glass 10 in each control cycle (Silo).

As such, the controller 40 may calculate the temperature and applied power of the heating glass 10 in the current control cycle based on the factors in the previous control cycle depending on control cycles that proceed sequentially.

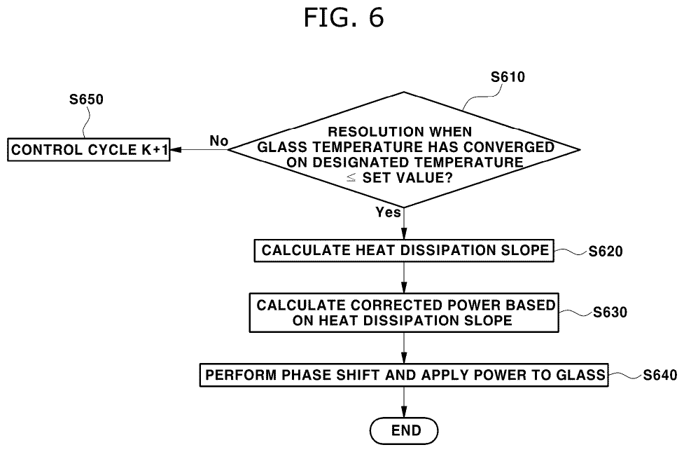

Moreover, the controller 40 calculates corrected power in consideration of the resolution of the sensor 20 after calculating the temperature and applied power of the heating glass 10 in each control cycle (S150). That is, as shown in FIG. 6, if the resolution of the sensor 20 is less than or equal to a set value (S610), the controller 40 calculates a heat dissipation slope depending on a temperature drop after reaching the designated temperature (S620). Here, in determining whether the resolution of the sensor 20 is less than or equal to the set value, the state after the temperature of the heating glass 10 has converged on the designated temperature is included as a condition, and in a section where the heating glass 10 maintains the designated temperature after the heating glass 10 has converged on the designated temperature, it is determined that the resolution of the sensor 20 is less than or equal to the set value under the condition that applied power of 0% or 100% from the power supply 30 is calculated.

Here, the resolution refers to the minimum unit of the temperature calculated through the sensor 20, and if a sensor 20 having a low resolution is applied, the applied power calculated in the section where the heating glass 10 maintains the designated temperature may not be applied to the heating glass 10 step by step, and 0% or 100% of power, which may be supplied from the power supply 30, is provided to the heating glass 10. Therefore, in order to provide appropriate applied power to the heating glass 10 including the sensor 20 having a low resolution, the applied power is corrected based on the heat dissipation slope (S630). Accordingly, the controller 40 calculates corrected power and provides phase-shifted corrected power to the heating glass 10 through phase shift of AC power of the two or more phases (S640).

On the other hand, if the resolution of the sensor 20 is greater than the set value, the controller 40 performs the next control cycle (S650).

As above, it is possible to optimize the applied power applied to the heating glass 10 depending on the resolution of the sensor 20, and a method of calculating the corrected power will be described in FIG. 6 below.

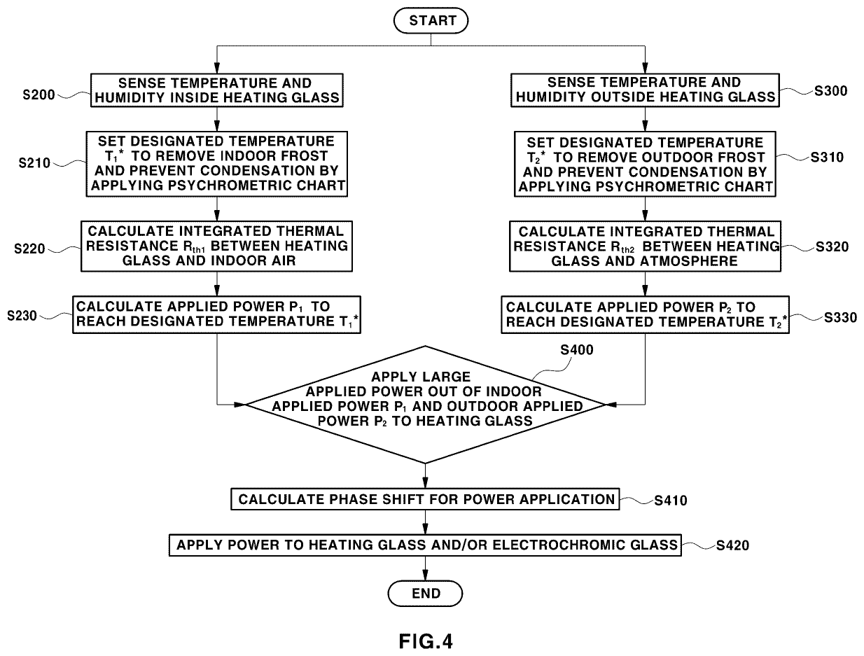

FIG. 4 is a flowchart representing a method of controlling the heating glass 10 if the heating glass 10 includes the outdoor sensor 21 and the indoor sensor 22, as another embodiment of the present disclosure.

The controller 40 receives indoor and outdoor temperatures and humidities inside and outside the heating glass 10 detected by the outdoor sensor 21 and the indoor sensor 22 (S200 and S300) and sets designated temperatures T₁* and T₂* corresponding to the received temperatures and humidities through the psychrometric chart stored in the controller 40 (S210 and S310). The controller 40 calculates an integrated thermal resistance Rₜₕ₁ between the heating glass 10 and the indoor air (S220) and an integrated thermal resistance Rₜₕ₂ between the heating glass 10 and the outdoor air or atmosphere based on the set designated temperatures T₁* and T₂* (S320).

The controller 40 calculates applied powers P₁ and P₂ respectively based on the calculated thermal resistances Rₜₕ₁ and Rₜₕ₂ (S230 and S330), and the controller 40 sets a relatively large applied power out of the applied powers P₁ and P₂ to apply the relatively large applied power to the heating glass 10 (S400).

Thereafter, the controller 40 performs phase shift of the relatively large applied power (S410) and applies power from the power supply 30 to the heating glass (S420).

Here, the controller 40 may simultaneously and independently perform the respective operations of calculating the applied power P₁ based on the information received from the indoor sensor 22 (S200 to S230) and the respective operations of calculating the applied power P₂ based on the information received from the outdoor sensor 21 (S300 to S330), and the controller 40 may then perform the operation of comparing the calculated applied powers P₁ and P₂ (S400).

As such, the control method according to embodiments of the present disclosure sets temperature model transfer functions by determining the thermal resistances and the heat capacities based on temperature and humidity conditions received by the respective sensors 21 and 22 depending on the control cycle and, in embodiments of the present disclosure, stable power is applied to the heating glass 10 by reflecting the driving environment changed depending on the control cycle by calculating the designated temperatures and applied powers of the heating glass 10.

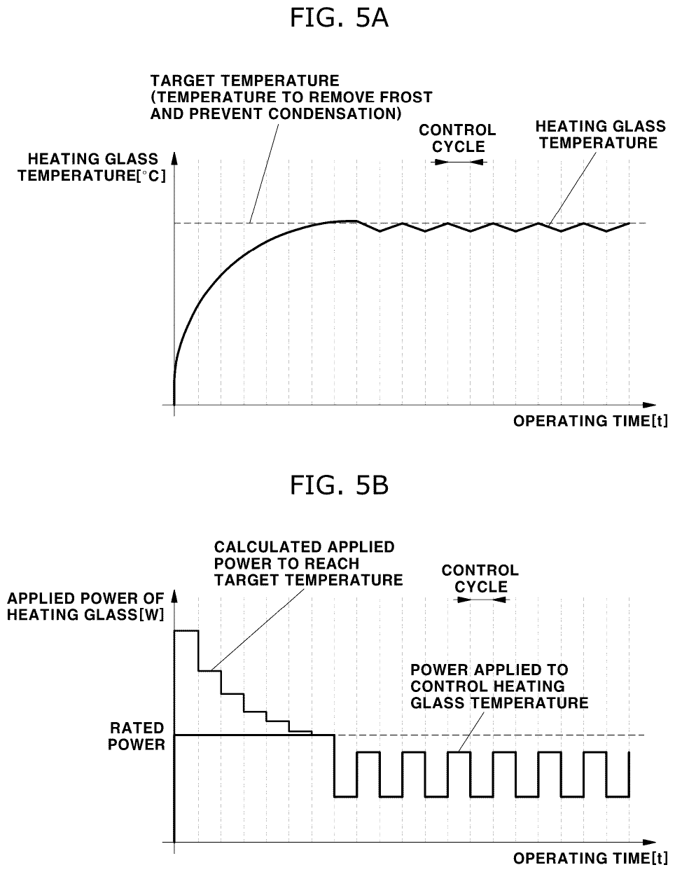

FIGS. 5A and 5B are graphs showing applied power depending on each control cycle and a resulting temperature state of the heating glass 10 in one embodiment of the present disclosure.

The controller 40 sets a designated temperature to remove frost and prevent condensation of the heating glass 10 through the temperature and humidity conditions measured by the sensor 20, and in this case, the controller 40 sets a designated temperature to a temperature at which the relative humidity becomes 80% to 90% based on the psychrometric chart stored in the controller 40.

The controller 40 calculates a temperature model transfer function based on the set designated temperature (target temperature), and the temperature model transfer function is determined based on the heat capacity and integrated thermal resistance of the heating glass 10. Further, the controller 40 performs phase shift of AC voltage of two or more phases based on the applied power applied to the heating glass 10 calculated through the temperature model transfer function. Therefore, the controller 40 is configured to apply AC power to the heating glass 10 through phase shift.

Furthermore, as shown in the drawings, the designated temperature and the applied power are determined based on each integrated thermal resistance and heat capacity depending on the control cycle. The controller 40 may calculate the temperature of the heating glass 10 in the current control cycle based on the integrated thermal resistance in the previous cycle and the applied power in the previous cycle, and the controller 40 may calculate the applied power in the current control cycle based on the calculated temperature of the heating glass 10 in the current cycle and the integrated thermal resistance calculated in the previous control cycle.

Accordingly, the controller 40 is configured to determine the temperature of the heating glass 10 in the current control cycle based on the integrated thermal resistance and the applied power in the previous control cycle and set the applied power in the current control cycle based on the temperature of the heating glass 10 in the current control cycle. Further, the controller 40 is configured to set the designated temperature depending on the temperature and humidity information measured by the sensor 20 in the current control cycle based on the temperature of the heating glass 10 in the current control cycle.

As shown in the drawings, the temperature of the heating glass 10 is controlled to converge on the designated temperature, and the applied power applied to the heating glass 10 is controlled so that, after the heating glass 10 has converged on the designated temperature, the heating glass 10 maintains the designated temperature.

FIG. 6 is a flowchart representing calculation of corrected power in consideration of the resolution of the sensor according to one embodiment of the present disclosure.

As shown in FIG. 6, if the resolution of the sensor 20 is greater than a set value in the state in which the temperature of the heating glass 10 has converged on the designated temperature (No in S610), the controller 40 performs the next control cycle (S650).

On the contrary, if the resolution of the sensor 20 is less than or equal to the set value (Yes in S610), a heat dissipation slope depending on a temperature drop after reaching the designated temperature is calculated (S620). Here, the set value may be set to the minimum unit of temperature including 0.5 degrees. Further, when the controller 40 determines whether the resolution of the sensor 20 is less than or equal to the set value, in the section in which the temperature of the heating glass 10 maintains the designated temperature after having converged on the designated temperature, the applied power calculated by the controller 40 refers to the condition that 0% or 100% of power, which may be provided from the power supply 30 to the heating glass 10, is calculated. That is, whether the resolution of the sensor 20 is less than or equal to the set value may be determined under the condition that only power of 0% or the maximum power of 100% from the power supply 30 is calculated as the applied power.

Therefore, the controller 40 is configured to provide the calculated applied power to the heating glass 10 and then calculate the corrected power in the control cycle in which the resolution of the sensor 20 is determined to be less than or equal to the set value.

In order to calculate the corrected power, the controller 40 calculates the heat dissipation slope in advance. The heat dissipation slope is calculated based on a time t_{d} at which the temperature of the heating glass 10 drops from the designated temperature by the minimum unit of the resolution after having converged on the designated temperature. That is, a slope at which the temperature drops by the minimum unit of the resolution after the measured temperature of the heating glass 10 reaches the designated temperature depending on the control cycle is determined as the heat dissipation slope, and the heat dissipation slope is calculated based on a time during a control cycle for which the applied power calculated by the controller 40 is 0 W (S620). Furthermore, the heat dissipation slope may be calculated by setting the time t_{d} before a point in time when the temperature of the heating glass 10 converges on the designated temperature and the resolution is determined to be less than or equal to the set value.

That is, the heat dissipation slope is calculated based on a temperature drop value determined based on a time at which the temperature drop by the minimum unit of the resolution of the sensor 20 is received as shown in Equation 2.

$$Δ {T}_{glass} = \frac{{T}_{glass} [ {K}_{t} - 1 ] - {T}_{glass} [ {K}_{t} ]}{{t}_{d}} \qquad Equation 2$$

(T_{glass}[Kₜ−1]: temperature of heating glass before temperature drop after reaching designated temperature, T_{glass}[Kₜ]: temperature of heating glass after temperature drop, t_{d}: time when temperature drop from designated temperature occurs, K: control cycle number.)

Further, since the corrected power including a correction value of the applied power may be calculated based on the heat dissipation slope, the corrected power is calculated as shown in Equation 3 (S630).

$${P}_{correct} [ K ] = {P}_{correct} [ K - 1 ] + {K}_{c} \times {P}_{r} \times Δ {T}_{glass} \times {t}_{samp} \qquad Equation 3$$

(P_{correct}[K]: corrected power, ΔT_{glass}: heat dissipation slope, tₛₐₘₚ: control cycle time, K: control cycle number, Pᵣ: rated power.)

Here, the rated power indicates power that causes no problem (breakage, etc.) of the heating glass 10, and if the applied power exceeding the rated power is calculated, the rated power is supplied to the heating glass 10. On the contrary, if the applied power less than or equal to the rated power is calculated, the calculated applied power is supplied to the heating glass 10.

The corrected power calculated in this way is applied to the heating glass 10 through phase shift (S640).

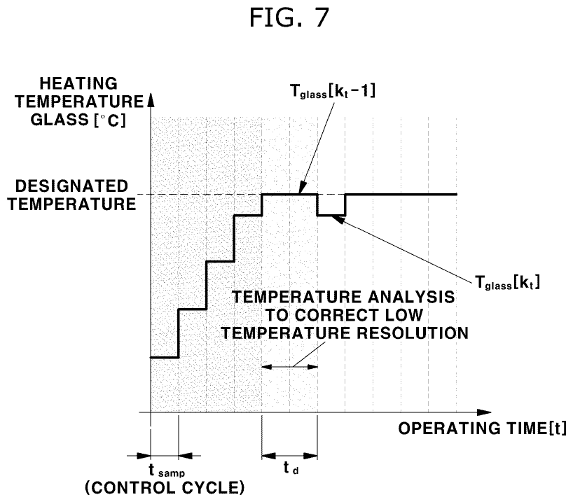

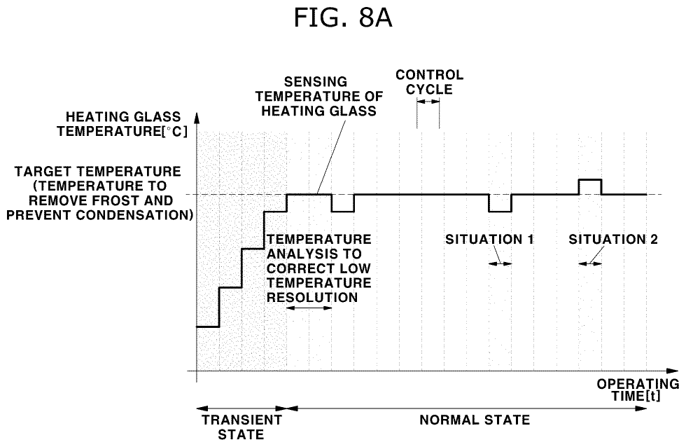

As shown in FIG. 7 and FIGS. 8A and 8B, the controller 40 calculates applied power so that the temperature of the heating glass 10 rises, performs phase shift of the calculated applied power, and then provides the applied power to the heating glass 10. Thereafter, if the temperature of the heating glass 10 measured by the sensor 20 converges on the designated temperature, the applied power is controlled to be 0 W.

However, if the resolution of the sensor 20 is less than or equal to the set value and the temperature drop value of the heating glass 10 is measured by the sensor 20, the controller 40 calculates the heat dissipation slope based on a time for which the designated temperature is maintained (a time before the temperature drop value of the heating glass 10 is measured). Here, whether the resolution of the sensor 20 is less than or equal to the set value is determined under the condition that the applied power calculated in a corresponding control cycle is calculated as 0% or 100% of the maximum power from the power supply 30 in the section in which the temperature of the heating glass 10 maintains the designated temperature.

The corrected power is calculated based on the heat dissipation slope calculated if the resolution of the sensor 20 is less than or equal to the set value, and thus, as shown in FIGS. 8A and 8B, the corrected power calculated by the controller 40 is applied to the heating glass 10.

Area A in FIG. 8B indicates a time when the temperature of the heating glass 10 converges on the designated temperature, and if the applied power is output as a power value of 0% or 100% of the power provided from the power supply 30 in response to a subsequent temperature drop of the heating glass 10, the resolution of the sensor 20 is determined to be less than or equal to the set value.

Further, if the resolution of the sensor 20 is determined to be less than or equal to the set value, that is, if the applied power is calculated as the power value of 0% or 100% of the power provided from the power supply 30 in the section where the heating glass 10 maintains the designated temperature, the controller 40 calculates the time t_{d} from a point in time when the temperature of the heating glass 10 has converged on the designated temperature to a point in time when the temperature of the heating glass 10 has first dropped. Here, the time t_{d} means a time of area A. Further, the controller 40 is configured to calculate the heat dissipation slope based on the corresponding time t_{d}. More preferably, the time t_{d} may mean a time for which the applied power calculated by the controller 40 is 0 W or a time for which the temperature of the heating glass 10 drops from the designated temperature by the minimum unit of the resolution of the sensor 20.

Moreover, the controller 40 is configured to calculate the corrected power depending on the heat dissipation slope. The corrected power may be calculated for the time and the calculated applied power depending on the control cycle.

In addition, if a change in the temperature of the heating glass 10 occurs in sections where the corrected power is applied, such as in area B and area C, it may be determined that a disturbance other than the control factors occurred in the heating glass 10. If a change occurs due to the disturbance after application of the corrected power, the controller 40 calculates the applied power by determining a first thermal resistance and applies the applied power to the heating glass 10. Therefore, in area B, it is determined that a disturbance in which the temperature is lowered has occurred, and 100% of power calculated as the applied power is applied to the heating glass 10. On the contrary, in area C, it is determined that a disturbance in which the temperature is raised has occurred, and the applied power is calculated as 0 W.

As such, in embodiments of the present disclosure, if power applied to the heating glass 10 is calculated as 0% or 100% of power supplied from the power supply 30 in the section where the temperature of the heating glass 10 converges on the designated temperature, the sensor 20 is determined to have a low resolution and corrected power is applied to the heating glass 10. Further, the controller 40 calculates the heat dissipation slope based on a point in time when the temperature of the heating glass 10 drops from the designated temperature, on which the temperature of the heating glass 10 has converged, and applies the corrected power to the heating glass 10 based on the calculated heat dissipation slope.

In addition, if a change in the temperature of the heating glass 10 occurs in a control cycle in which the corrected power is applied, the controller 40 determines that the temperature change is due to a disturbance, calculates the applied power, and provides the calculated applied power. That is, the controller 40 calculates the applied power based on a thermal resistance in response to disturbance conditions and applies the applied power to the heating glass 10, and thereby, a stable method of controlling a glass may be provided.

As is apparent from the above description, embodiments of the present disclosure may obtain the following effects through the above-described configuration, combinations, and usage relations disclosed in the embodiments.

Embodiments of the present disclosure provide a system for controlling a heating glass that may calculate applied power, in which the real-time driving environment of a vehicle is reflected, and may thus have the effect of calculating accurate applied power in a corresponding control cycle.

Further, embodiments of the present disclosure calculate a thermal resistance depending on a control cycle and may thus have the effect of providing the applied power having a fixed duty ratio to the heating glass.

In addition, embodiments of the present disclosure calculate the applied power by equalizing electrical parameters into a temperature model transfer function and may thus have the effect of providing a simple control algorithm.

Moreover, embodiments of the present disclosure may correct the applied power and apply the corrected power to the heating glass if a low-resolution sensor is applied, thereby providing an effective driving environment that provides less power compared to the resolution of the sensor.

The present disclosure described as above is not limited by the embodiments described herein and the accompanying drawings. It should be apparent to those skilled in the art that various substitutions, changes, and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A method of controlling a heating glass, the method comprising:
setting a designated temperature of the heating glass depending on temperature and humidity conditions measured through a sensor;
calculating an applied power to reach the designated temperature based on an integrated thermal resistance formed in the heating glass;
performing a phase shift of alternating current (AC) power of two or more phases to provide the calculated applied power to a load of the heating glass; and
calculating a corrected power in consideration of a resolution of the sensor,
wherein respective operations are controlled depending on a set control cycle.

2. The method of claim 1, wherein setting the designated temperature comprises:
receiving outdoor temperature and humidity conditions and indoor temperature and humidity conditions of a vehicle through an outdoor sensor located outside the vehicle and an indoor sensor located inside the vehicle; and
setting designated temperatures based on the received outdoor temperature and humidity conditions and the received indoor temperature and humidity conditions of the vehicle.

3. The method of claim 2, further comprising:
calculating an outdoor integrated thermal resistance and an indoor integrated thermal resistance through the outdoor temperature and humidity conditions and the indoor temperature and humidity conditions of the vehicle;
calculating an outdoor applied power depending on the calculated outdoor integrated thermal resistance and an indoor applied power depending on the calculated indoor integrated thermal resistance; and
providing a relatively large applied power by comparing the calculated outdoor applied power and the calculated indoor applied power with each other.

4. The method of claim 3, wherein the applied power in a current control cycle is calculated through an equation below.
$${R}_{th} [ K - 1 ] = \frac{{T}_{glass} [ K ] - {T}_{glass} [ K - 1 ]}{P [ K - 1 ]} , P [ K ] = \frac{T * - {T}_{glass} [ K ]}{{R}_{th} [ K - 1 ]}$$
in which Rₜₕ represents the integrated thermal resistance, T_{glass} represents a temperature of the heating glass, T* represents a designated temperature, and K represents a control cycle number.

5. The method of claim 3, wherein the integrated thermal resistance is a sum of a radiative thermal resistance and a convective thermal resistance of the heating glass.

6. The method of claim 3, wherein the integrated thermal resistance is calculated in consideration of a heat loss of the heating glass.

7. The method of claim 1, wherein setting the designated temperature of the heating glass the comprises setting the designated temperature to a temperature at which relative humidity is 80% to 90% based on a psychrometric chart.

8. The method of claim 1, wherein in setting the designated temperature of the heating glass depending on the temperature and humidity conditions measured through the sensor, the temperature of the heating glass in a current control cycle is calculated based on the integrated thermal resistance and the temperature of the heating glass in a previous control cycle through an equation
$${R}_{th} [ K - 1 ] = \frac{{T}_{glass} [ K ] - {T}_{glass} [ K - 1 ]}{P [ K - 1 ]} , P [ K ] = \frac{T * - {T}_{glass} [ K ]}{{R}_{th} [ K - 1 ]}$$
in which P[K] represents the applied power in a K^{th} control cycle, Rₜₕ represents the integrated thermal resistance, T_{glass} represents the temperature of the heating glass, T* represents the designated temperature, and K represents a control cycle number.

9. A method of controlling a heating glass, the method comprising:
setting a designated temperature of the heating glass depending on temperature and humidity conditions measured through a sensor;
calculating an applied power to reach the designated temperature based on an integrated thermal resistance formed in the heating glass;
performing a phase shift of alternating current (AC) power of two or more phases to provide the calculated applied power to a load of the heating glass; and
calculating a corrected power in consideration of a resolution of the sensor, the calculating comprising:
in response to the resolution of the sensor being less than or equal to a set value, calculating a heat dissipation slope depending on a temperature drop after reaching the designated temperature of the heating glass;
setting the corrected power based on the calculated heat dissipation slope; and
performing the phase shift of the AC power of the two or more phases to provide the corrected power to the load of the heating glass;
wherein respective operations are controlled depending on a set control cycle.

10. The method of claim 9, wherein it is determined the resolution of the sensor is less than or equal to the set value in a case in which the power applied to the heating glass after the temperature of the heating glass has converged on the designated temperature has a power value of 0% or 100% of the power supplied from a power supply.

11. The method of claim 9, wherein, in response to the resolution of the sensor being less than or equal to the set value, the corrected power is set after the applied power calculated in the set control cycle has been applied to the heating glass.

12. The method of claim 9, wherein the heat dissipation slope is calculated through an equation
$$Δ {T}_{glass} = \frac{{T}_{glass} [ {K}_{t} - 1 ] - {T}_{glass} [ {K}_{t} ]}{{t}_{d}}$$
in which (T_{glass}[Kₜ−1] represents the temperature of the heating glass before the temperature drop after reaching the designated temperature, T_{glass}[Kₜ] represents the temperature of the heating glass after the temperature drop, t_{d} represents a time at which the temperature drop from the designated temperature occurs, and K represents a control cycle number.

13. The method of claim 9, wherein the corrected power is calculated through an equation P_{correct}[K]=P_{correct}[K−1]+K_{c}×Pᵣ×ΔT_{glass}×tₛₐₘₚ in which P_{correct}[K] represents the corrected power, ΔT_{glass} represents the heat dissipation slope, tₛₐₘₚ represents a control cycle time, K represents a control cycle number, and Pᵣ represents a rated power.

14. The method of claim 9, wherein calculating the heat dissipation slope depending on the temperature drop after reaching the designated temperature of the heating glass comprises calculating the heat dissipation slope based on a time for which the applied power is 0 W.

15. The method of claim 14, wherein the heat dissipation slope is calculated based on a time at which the temperature of the heating glass drops from the designated temperature by an amount corresponding to a minimum unit of the resolution of the sensor.

16. The method of claim 9, wherein it is determined that a disturbance has been occurred in the heating glass and wherein, in performing the phase shift of the AC power of the two or more phases to provide the corrected power to the load of the heating glass, the applied power is calculated and provided to the heating glass.

17. A system comprising:
a controller; and
a memory storing an algorithm that, when executed by the controller, causes the system to:
set a designated temperature of a heating glass depending on temperature and humidity conditions measured through a sensor;
calculate an applied power to reach the designated temperature based on an integrated thermal resistance formed in the heating glass;
perform a phase shift of alternating current (AC) power of two or more phases to provide the calculated applied power to a load of the heating glass; and
calculate a corrected power in consideration of a resolution of the sensor,
wherein the controller is configured to control respective operations depending on a set control cycle.

18. The system of claim 17, wherein the algorithm causes the system to set the designated temperature by:
receiving outdoor temperature and humidity conditions and indoor temperature and humidity conditions of a vehicle through an outdoor sensor located outside the vehicle and an indoor sensor located inside the vehicle; and
setting designated temperatures based on the received outdoor temperature and humidity conditions and the received indoor temperature and humidity conditions of the vehicle.

19. The system of claim 17, wherein the algorithm causes the system to set the designated temperature of the heating glass by setting the designated temperature to a temperature at which relative humidity is 80% to 90% based on a psychrometric chart.

20. The system of claim 17, wherein the algorithm causes the system to calculate the corrected power by:
calculating a heat dissipation slope depending on a temperature drop after reaching the designated temperature of the heating glass, the calculating performed in response to the resolution of the sensor being less than or equal to a set value;
setting the corrected power based on the calculated heat dissipation slope; and
performing the phase shift of the AC power of the two or more phases to provide the corrected power to the load of the heating glass.
